(19) United States
(12) Patent Application Publication
(10) Pub. No.: US 2004/0022236 A1
(43) Pub. Date: Feb. 5, 2004

(54) Communication of queue status in a packet

(76) Inventors: John P. Blanco, Boulder, CO (US); Matthew D. Morris, Long Beach, CA (US); William F. Daniel, Louisville, CO (US); Richard M. Heidebrecht, Niwot, CO (US); David M. Kissel, Boulder, CO (US); Mark L. Millican, Longmont, CO (US)

Correspondence Address: BUCKLEY, MASCHOFF, TALWALKAR LLC, 5 ELM STREET, NEW CANAAN, CT, 06840, US

(21) Appl. No.: 10/209,437

(22) Filed: Jul. 31, 2002

(51) Int. Cl. H04L 12/66

(52) U.S. Cl. 370/353; 370/356; 370/466

(57) ABSTRACT

A method, apparatus, and system for determining and indicating packet queue readiness.

### BACKGROUND OF THE INVENTION

In digital networks, certain packet processing integrated circuits communicate a packet queue status that indicates for each packet processing integrated circuit whether that packet processing integrated circuit has space to accept additional packets or whether that packet processing integrated circuit has no space to accept additional packets, wherein the status is accessible over a communication bus by accessing the memory of the packet processing integrated circuit. Other integrated circuits, however, are better suited to read packet queue status by reading that status from packets rather than reading that status from memory. Thus, there may be a need for a system, apparatus, and method of transmitting packet queue status in a packet.

### BRIEF DESCRIPTION OF THE DRAWINGS

The subject matter regarded as embodiments of the invention is particularly pointed out and distinctly claimed in the concluding portion of the specification. Embodiments of the invention, however, both as to organization and method of operation, together with objects, features, and advantages thereof, may best be understood by reference to the following detailed description wherein like reference numerals are employed to designate like parts or steps, when read with the accompanying drawings in which:

FIG. 1 is a communication network suitable for practicing an embodiment of the invention;

FIG. 2 is an embodiment of a signal processing integrated circuit suitable for practicing an embodiment of the invention;

FIG. 3 is a block diagram of a system having a TDM/packet converter suitable for practicing an embodiment of the invention;

FIG. 4 is a flow chart illustrating a method suitable for practicing an embodiment of the invention;

FIG. 5 is a packet structure chart suitable for use in an embodiment of the invention; and

FIG. 6 is a block diagram of a system having a TDM/packet converter that is suitable for time stamping packets.

### DETAILED DESCRIPTION OF THE INVENTION

Reference will now be made in detail to the preferred embodiments, examples of which are illustrated in the accompanying drawings. It is to be understood that the Figures and descriptions of embodiments included herein illustrate and describe elements that are of particular relevance, while eliminating, for purposes of clarity, other elements found in typical computers and computer networks.

The present bus communication of packet queue status provides solutions to the shortcomings of certain packet processing integrated circuits. Those of ordinary skill in the art will readily appreciate that the invention, while described in connection with an IXS1000 integrated circuit and an IXP1200 integrated circuit, is equally applicable to any packet processing integrated circuits. Other details, features, and advantages of the bus communication of packet queue status will become further apparent in the following detailed description of the embodiments.

Any reference in the specification to “one embodiment,” “a certain embodiment,” or a similar reference to an embodiment is intended to indicate that a particular feature, structure or characteristic described in connection with the embodiment is included in at least one embodiment of the invention. The appearances of such terms in various places in the specification are not necessarily all referring to the same embodiment. References to “or” are furthermore intended as inclusive so “or” may indicate one or the other ored terms or more than one ored term.

The Internet is a network of nodes such as computers, dumb terminals, or other, typically processor-based, devices interconnected by one or more forms of communication media. Typical interconnected devices range from handheld computers and notebook PCs to high-end mainframe and supercomputers. The communication media coupling those devices include twisted pair, co-axial cable, optical fibers and wireless communication methods such as use of radio frequencies.

Network nodes may be equipped with the appropriate hardware, software or firmware necessary to communicate information in accordance with one or more protocols. A protocol may comprise a set of instructions by which the information is communicated over the communications medium. Protocols are, furthermore, often layered over one another to form something called a “protocol stack.” In one embodiment, the network nodes operate in accordance with a packet switching protocol referred to as the User Datagram Protocol (UDP) as defined by the Internet Engineering Task Force (IETF) standard 6, Request For Comment (RFC) 768, adopted in August, 1980 (“UDP Specification”), and the Internet Protocol (IP) as defined by the IETF standard 5, RFC 791 (“IP Specification”), adopted in September, 1981, both available from “www.ietf.org.” In another embodiment, Transmission Control Protocol (TCP) as defined by the Internet Engineering Task Force (IETF) standard 7, Request For Comment (RFC) 793, adopted in September, 1981 (“TCP Specification”) may be used with IP.

In the present embodiment, “transmitting entities” and “receiving entities” are network nodes that may include a processor or a computer coupled to a network such as, for example, the World Wide Web and that communicates with other processors on the network via, for example, a voice over IP application or a conferencing application (e.g., Microsoft® Netmeeting®) that communicates between applications operating on the node and the UDP/IP protocol stack. UDP is a network communications protocol that offers lesser services than TCP. For example, UDP may provide port numbers to distinguish different user requests and a checksum to verify that data arrived intact. UDP may not provide sequencing of the packets or retransmission of unreceived packets. After the packets are created, the IP layer transmits the packets across a network such as the Internet.

Nodes may operate as source nodes, destination nodes, intermediate nodes or a combination of those source nodes, destination nodes, and intermediate nodes. Information is passed from source nodes to destination nodes, often through one or more intermediate nodes. Information may comprise any data capable of being represented as a signal, such as an electrical signal, optical signal, acoustical signal and so forth. Examples of information in this context may include data from a voice conversation, videoconference, streaming video, electronic mail (“email”) message, voice mail message, graphics, image, video, text and so forth.

An embodiment is contemplated in which a gateway 52 communicates information between a Public Switched Telephone Network (PSTN) and a packet-based network. Moreover, a transmitting entity typically transmits the information on either the PSTN or packet-based network and a receiving entity typically receives the information from either the PSTN or packet-based network.

The PSTN is a collection of networks operated, for the most part, by telephone companies and administrational organizations. Digital information, such as data transmitted by a computer or facsimile machine, may be transmitted on the PSTN. Analog information, such as voice communications transmitted by a telephone, may also be transmitted on the PSTN. Such analog information is often converted into a digital signal at, for example, the telephone company. The digitized analog information is typically transmitted using a technique called Time Division Multiplexing (TDM). The digitized analog information may be transmitted, for example, from one telephone company to another telephone company, and then converted back to an analog format prior to delivery to the receiving entity. Information in TDM format may be transmitted over a synchronous network. Thus, all elements of the network carrying the TDM formatted information may be synchronized one with another. In that way, for example, voice data may be received nearly instantly after it is transmitted and a conversation may be conducted such that there is no discernable delay between transmission and reception of the voice communication.

Packet-based networks such as, for example, those using X.25, frame-relay, cell-relay or asynchronous transfer mode (ATM) may not be synchronous. Thus, a transmission sent over a non-synchronous network may be separated into a plurality of packets. Those packets may then be sent across the network, possibly by a variety of routs and, sometimes, with certain packets taking a discernable interval of time to arrive at the receiving entity. The receiving entity arranges the packets back into the transmitted information periodically, for example, once all packets are received or each time the next packet of streaming type information is received and then may deliver the transmitted information to a user in the order in which that information is to be reconstructed.

Packets may be delayed in transmission due to, for example, network congestion or failure and retransmission of a packet. Such delay in packet delivery is referred to as “jitter.” Minimization of jitter is important in various communications including, for example, transmissions of voice communications, streaming audio, and streaming video. When jitter occurs during transmission of voice communications, the received voice may halt at times when the transmitted voice did not halt, causing the received communication to be broken and unnatural.

A method of reading a plurality of statuses from memory locations of integrated circuits and packaging those statuses into one or more packets to be transmitted across a network and read by a packet processing integrated circuit is contemplated. In that method, a plurality of queue statuses may be read from, for example, one or more first integrated circuits such as signal processors. Those queue statuses may be stored in memory of, for example, a memory to packet bridge. The queue statuses may then be transmitted from the memory to packet bridge to, for example, an integrated circuit such as a packet processor.

An article of manufacture is also contemplated. The article of manufacture includes a computer readable medium having stored thereon instructions which, when executed by a processor, cause the processor to read a plurality of queue statuses, store the plurality of queue statuses in memory, and transmit the queue statuses stored in memory in a packet format.

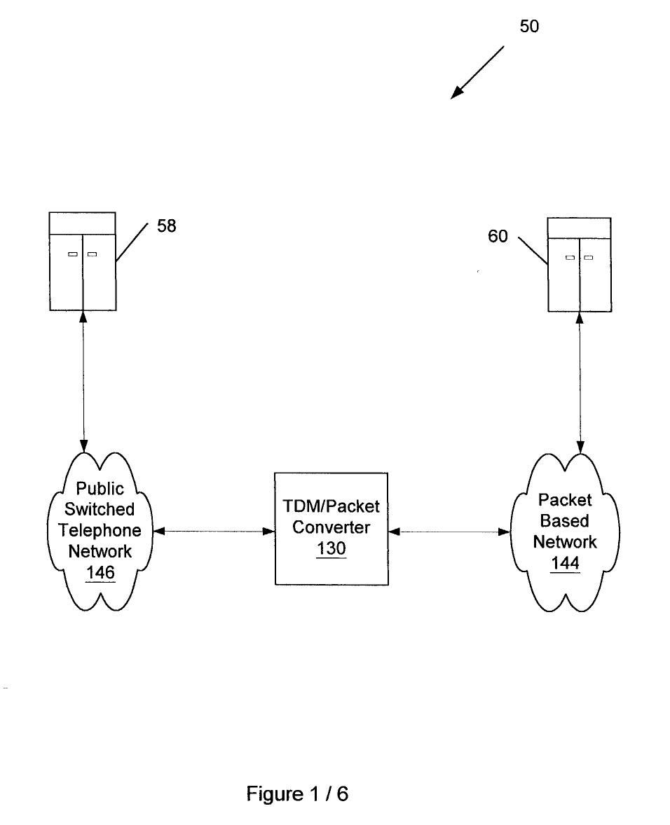

FIG. 1 illustrates a communication network 50 in which a transmitting entity 58 communicates information in TDM format to a receiving entity 60 that receives the information in a packet-based format. The transmitting entity 58 may, thus, transmit TDM formatted information across the PSTN 146. That TDM formatted information may be converted to the packet-based format by a TDM/packet converter 130 and transmitted across the packet-based network 144 to the receiving entity 60. Furthermore, the receiving entity 60 could also act as a transmitting entity and the transmitting entity 58 could act as a receiving entity, for example wherein two-way communication is occurring between those entities 58 and 60.

In digital networks, certain integrated circuits have been developed that store data in memory that is intended to be accessed by other integrated circuits to provide, for example, a status of the integrated circuit. An example of such an integrated circuit that stores status in its memory is a signal processing integrated circuit that supports network communications. For example, the IXS1000 manufactured by Intel® is a system-on-a-chip that employs voice over packet (VoP) technology to deliver voice, fax, and data communications over packet-based and TDM-based networks. The IXS1000 accepts circuit switched network traffic, such as voice traffic, and outputs the traffic in voice over internet protocol (VoIP) and voice over asynchronous transfer mode (VoATM). The IXS1000 does so by aggregating time division multiplex (TDM) channels, performing voice/fax-processing and telephony functions on each channel, and then creating and transmitting voice packets containing the information originally contained in the TDM channels. The IXS1000 also converts packet-based voice data into TDM-based voice data.

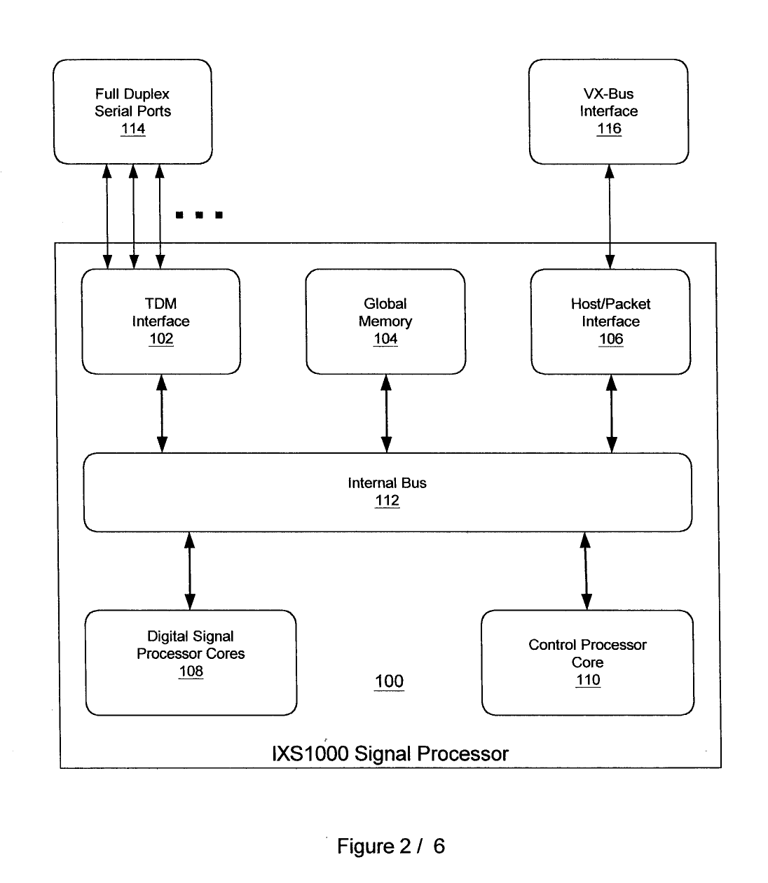

FIG. 2 illustrates an embodiment of an IXS1000 signal processing integrated circuit 100. The IXS1000 integrated circuit 100 includes a TDM interface 102, global memory 104, a host/packet interface 106, digital signal processor cores 108, and a control processor core 110. The TDM interface 102, the global memory 104, the host/packet interface 106, the digital signal processor cores 108, and the control processor core 110 communicate by way of an internal bus 112. The TDM interface receives TDM formatted information at a plurality of full-duplex serial ports 114. The host-packet interface transmits the messages received at the TDM interface in a packet format at the VX-Bus interface.

The IXS1000 integrated circuit 100 communicates a plurality of packet queue statuses to other devices by placing the statuses in a memory locations and permitting the other devices to access those memory locations. In the example presented herein, the IXS1000 communicates the status of 512 packet queues by way of 512, memory locations.

Each packet queue status may be a particular value when the packet processing integrated circuit has space to accept at least one additional packet and another particular value when the packet processing integrated circuit does not have space to accept any additional packets. That packet queue status may be expressed logically as a packet queue status flag having two possible values. Moreover, the packet queue status flag may be expressed as a bit that is either magnetized or not magnetized and the bit may be read, for example, as values of 0 and 1, or true and false depending on its state.

It should be recognized that, while the IXS1000 is utilized as an example herein, the present invention applies to any integrated circuit that is designed to have information read from its memory by another integrated circuit.

Also in digital networks, certain network processors have been developed to perform a variety of functions in connection with data transmitted on a network. One function of the network processor is to manipulate data in a packet formatted to be transmitted on the network. For example, the network processor may read contents of a packet such as, for example, a packet header and determine routing for the packet therefrom. The network processor may also or alternately place data in a packet. The IXP1200 manufactured by Intel® is an example of such a network processor. Such a processor may be utilized to send packets to a packet processing integrated circuit such as, for example, an IXS1000. It may furthermore be desired that such a processor send packets only to a packet processing integrated circuit that is not being fully utilized. Therefore, it may be desirable, for example, for an IXP1200 to read packet queue status from multiple IXS1000s to determine which IXS1000 is not fully utilized. A network processor, such as an IXP1200 may not, however, be adept at reading packet queue statuses from memory locations but may, rather, be adept at reading packet queue statuses from a packet. Thus there is a need for a memory-to-packet bridge capable of reading packet queue statuses from memory locations, placing those statuses in a packet and transmitting that packet of packet queue statuses to a device such as the IXP1200.

In an embodiment, a memory-to-packet bridge reads packet queue statuses from the memory of an IXS1000 and places that data into a packet format that may be efficiently read by the network processor. The packet queue statuses of an IXS1000 may be read by the memory-to-packet bridge in sixteen sets of thirty-two packet queue statuses and written to RAM. Those statuses may then be transmitted to an IXP1200 in packets containing sixty-four packet queue statuses each. An identifier of the IXS1000 with which the statuses are associated may also be sent in a package to the IXP1200. The memory-to-packet bridge may, thereby access packet queue statuses of a plurality of IXS1000s and communicate those statuses to one or more IXP1200 network processors in a packets.

A Virtex-E XCV200E-6FG256C field-programmable gate array manufactured by Xilinx of San Jose Calif. may be utilized to perform the memory-to-packet bridge function in one embodiment.

A system for communicating queue status in a packet is also contemplated. The system includes a first integrated circuit having memory containing a queue status, a memory to packet bridge, and a second integrated circuit receiving the queue status from the memory to packet bridge in a packet format. The memory to packet bridge has memory into which contents of the queue status location of the first integrated circuit may be read. The memory to packet bridge then transmits the contents of the queue status location of the first integrated circuit from the memory to packet bridge memory to the second integrated circuit.

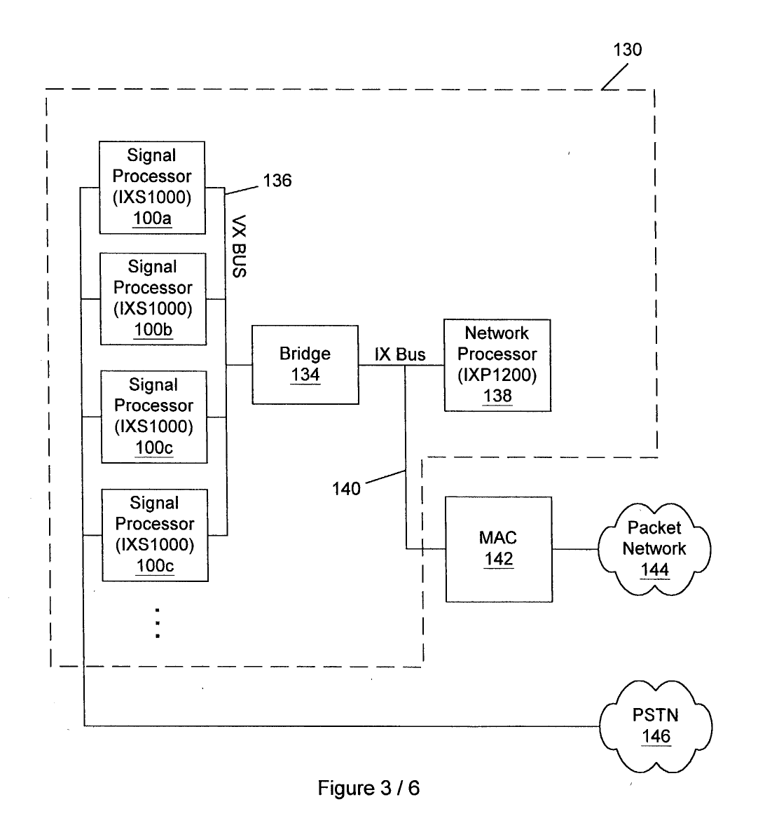

FIG. 3 is a block diagram of a TDM/packet converter 130 in which a field-programmable gate array serves as a memory-to-packet bridge 134 to communicate IXS1000 packet queue statuses from IXS1000 integrated circuits to an IXP1200. IXS1000 integrated circuits 100a, 100b, 100c, and 100d (hereinafter referred to collectively as 100) communicate packet queue status to the memory-to-packet bridge 134 across a VxBus 136. The VxBus 136 is a proprietary communication bus utilized by IXS1000 integrated circuits 100. The memory-to-packet bridge 134 assembles those packet queue statuses into one or more packets and communicates those packets to the IXP1200 network processor 138. The memory-to-packet bridge 134 communicates with the IXP1200 network processor 138 on an IX Bus 140, which is a proprietary communication bus utilized by IXP1200 network processors 138. The media access control (MAC) integrated circuit 142 communicates packets of data from the TDM/packet converter 130 to a packet network 144 or communicates packets of data from the packet network 144 to the TDM/packet converter 130. Moreover, the IXS1000 integrated circuits 100 communicate with a PSTN 146 in this embodiment. Thus packets may be received and converted to TDM format or TDM formatted information may be received and converted to packet format by the TDM/packet converter 130. That conversion may also be performed efficiently because the memory-to-packet bridge 134 assures that the IXP1200 is aware of the packet queue status of each IXS1000 so that the IXP1200 may communicate packets only to less than fully utilized IXS1000 integrated circuits.

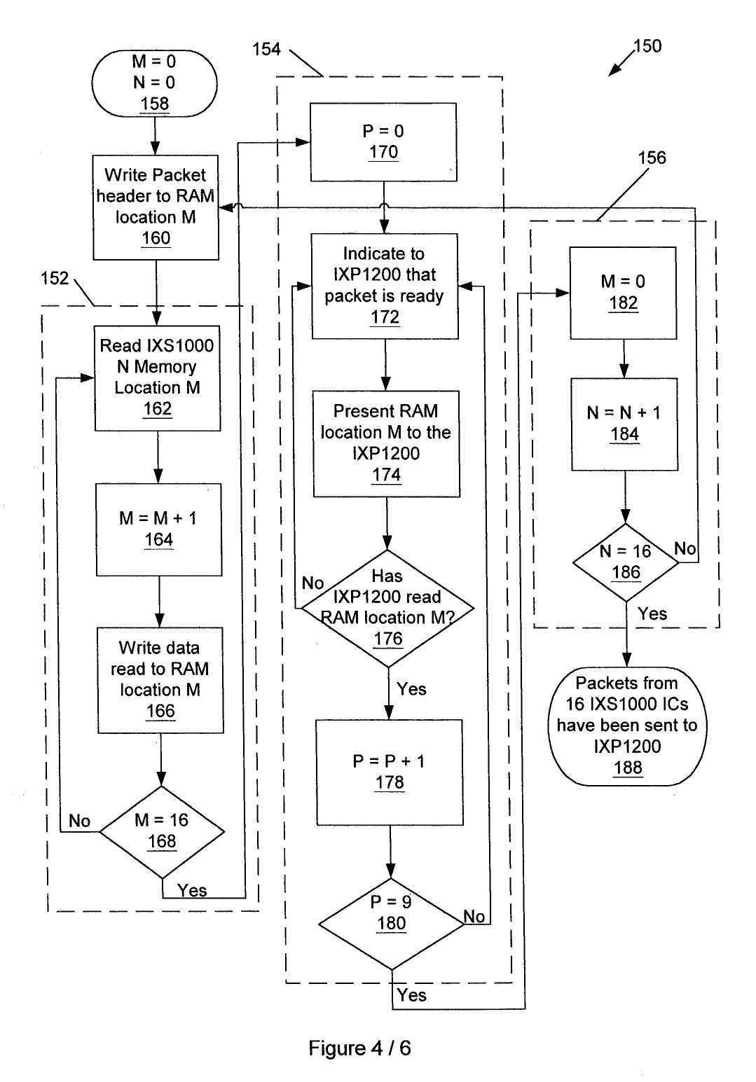

FIG. 4 is a flow chart that describes the operation of the memory-to-packet bridge 134 in an embodiment. The memory to packet conversion 150 includes reading 16 sets of 32-bit packet queue statuses from an IXS1000 at 152. At 154, the packet queue statuses read at 152 are transmitted to the IXP1200 in 8 sets of 64-bit quadwords, along with an identifier of the IXS1000 to which the statuses belong. The process of reading and writing packet queue statuses is repeated for 15 additional IXS1000 integrated circuits at 156.

M, which is the memory location, is initialized to 0 and N, which is the number of the IXS1000 device is also initialized to 0 at 158. At 160 a packet header is written to memory location 0. The packet header identifies the ISX1000 from which status bits are being read.

At 162, memory location M of IXS1000 N is read. That memory location holds a queue status. At 164, memory location M is incremented by one. At 166, the 32 packet queue statuses read at 162 are written to memory location M of RAM. For example, where N=0, a read operation is performed on IXS1000 device number 0. Where M=0, information is read from memory location 0 of IXS1000 device number 0. That read information is then written to memory location 0 in RAM. At 168, a check is performed. At 168, if M does not equal 16, 162 is repeated to fill the next memory location. If M does equal 16 at 168, then all packet queue statuses have been read from a particular IXS1000 and the process proceeds to 170.

At 154, nine quad-words containing 64-bits each are sent to the IXP1200 to communicate an identifier of the IXS1000 for which status is being transmitted and 512 queue statuses related to that IXS1000. At 170, P is set to 0. At 172, the IXP1200 is notified that a 64-bit quad-word is ready to be transmitted. The first quad-word contains the IXS1000 identifier and the eight following quad-words contain the packet queue statuses for that IXS1000 integrated circuit. At 174, the quad-word contained in memory location P of RAM is sent to the IXP1200. It should be recognized that packet queue statuses were written to RAM in 16 sets of 32 bits at 152 and that those packet queue statuses are read from the same RAM in 8 sets of 64-bits each at 154. At 176, a check is performed to determine if the quad-word has been read by the IXP1200. If the quad-word has not been read, 172 is repeated. If the quad-word has been read, P is incremented by one at 178. A check is performed at 180 to determine whether P is equal to nine. If P does not equal nine, then all of the packet queue statuses have not been transmitted to the IXP12000 and so 172 is repeated and the IXP1200 is notified that the next 64 bit quad-word is ready to be transmitted. If P does equal nine, memory location M is reset to 0 at 182.

At 184, IXS1000 device number N is incremented by one so that packet queue status may be read from the next IXS1000. A check is performed at 186 to determine if N equals 16. If N does not equal 16, the process of reading and transmitting packet queue statuses is repeated beginning at 160. If N does equal 16, packets from all 16 IXS1000 chips have been successfully sent to the IXP1200 and the memory to packet conversion is terminated at 188.

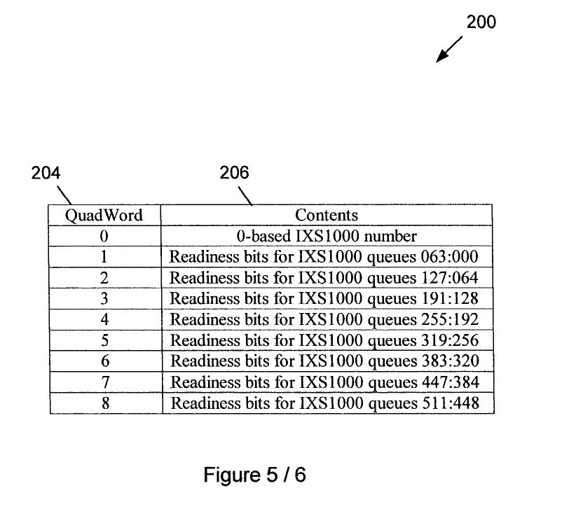

FIG. 5 is a packet structure chart 200 illustrating the structure of packet queue status packets or readiness packets (not shown) in an embodiment. Column 204 indicates a quad-word number, which is a set of 64 bits that are to be transmitted in a readiness packet. Column 206 indicates information stored in each quad-word. Thus, the bits of quad-word 0 indicate a number or other identifier of the integrated circuit to which the associated packet queue statuses apply. The bits of quad-word 1 contain a current status for 64 packet queue status flags contained within the identified integrated circuit. Those packet queue status flags may, for example, be packet queue statuses read from an IXS1000. The flags in quad-word one may be numbered 0-63. The bits of quad-word 2 contain a status for the next 64 flags of the identified integrated circuit and so on through quad-word 8, such that the status of 512 packet queues are contained in eight readiness packets.

In the examples provided herein, packet queue readiness status is communicated in the readiness packets. It should be recognized, however, that any status could be placed in the readiness packets. The examples described herein also utilize the IXS1000 as the integrated circuit from which statuses are retrieved to be stored in the readiness packet. It should also be recognized, however, that statuses retrieved from the memory of any integrated circuit may be stored in the readiness packet.

In an embodiment a bit in a state read as a “1” may indicate that a queue has space in which it can receive at least one additional packet and a “0” may indicate that a queue does not have space in which it can receive an additional packet or vice versa. Alternately, for example, a “true” may indicate that a queue has space in which it can receive at least one additional packet and a “false” may indicate that a queue does not have space in which it can receive an additional packet or vice versa.

There is also a need for an apparatus, a system, and a method for measuring jitter. A reference clock that associates a received time with every packet is therefore disclosed. Associating a received time with a packet is commonly referred to as “time stamping.”

Certain network processors such as, for example the IXP1200, do not have a reference clock and, therefore, may not time stamp packets. A field programmable gate array (FPGA) may, therefore, be coupled to the network processor to assist in time stamping receipt time of packets at the IXP1200.

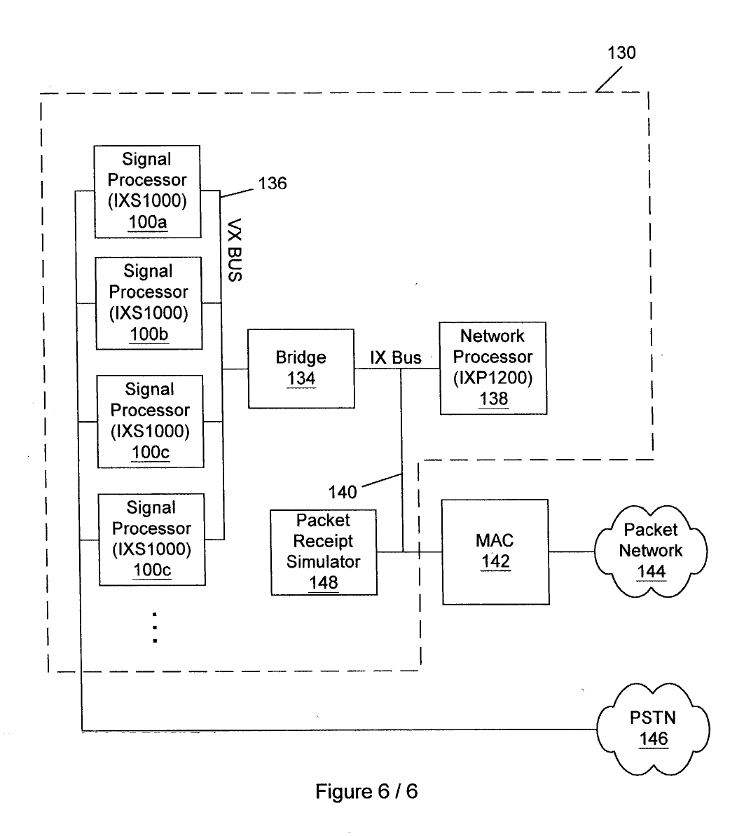

FIG. 6 is a block diagram of a TDM/packet converter 130 in which a field-programmable gate array serves as a packet receipt simulator 148 that is coupled to a network processor such as, for example, an IXP1200. IXS1000 signal processing integrated circuits 100a, 100b, 100c, and 100d communicate TDM-based information received from a PSTN 146 to an IXP1200 network processor 138 and communicate packet-based information received from the IXP1200 network processor 138 to the PSTN 146 in a TDM format. The IXP1200 network processor 138 communicates packet-based information received from a packet network 144 to IXS1000 signal processors 100 and communicates TDM-based information received from the IXS1000 signal processors 100 to the packet-based network in a packet format. The media access control (MAC) integrated circuit 142 communicates packets of data from the TDM/packet converter 130 to a packet network 144 or communicates packets of data from the packet network 144 to the TDM/packet converter 130.

When converting asynchronous packet formatted information received from the packet-based network 144 to TDM formatted information to be transmitted on the PSTN 146, the MAC 142 receives the packets from the packet-based network 144. The MAC 142 interfaces between the physical portion of the packet-based network 144 and a logical link control of a node such as, for example, the packet receipt simulator 148 or IXP1200 138 and is known to those skilled in the art.

In an embodiment, a method of time stamping a packet is contemplated. In that method, a regular periodic signal is received. The regular periodic signal may be a simulated packet that is generated by a packet receipt simulator such as, for example, a field-programmable gate array. A counter is incremented each time the regular periodic signal is received. That counter may be a counter resident in a network processor such as, for example, an IXP1200 network processor. The value of the counter may then be applied to one or more packets, for example as the packets are received, as an indication of the time at which the packets were received by the network processor.

An article of manufacture is also contemplated. The article of manufacture includes a computer readable medium having stored thereon instructions which, when executed by a processor, cause the processor to receive a regular periodic signal, increment a counter each time the signal is received, and apply the counter to the packet.

The time stamp may be used by the network processor 138 to determine the amount of jitter being experienced. Packet transmission delay time may be calculated by comparing packet receipt time to the time at which the packet was sent. The time at which a packet was sent is often included in the header of a packet and may be read by the network processor. An amount of time to delay delivery of packets may be calculated based on packet transmission delay time, known as a “jitter buffer,” may then be calculated to minimize jitter. Jitter buffer strategies are known to those skilled in the art. One strategy is to generate a fake frame of data to increase delay in the data flow by one frame of data, or discard a frame of data to reduce the delivery delay.

The packet receipt simulator 148 simulates receipt of packets at a time interval such as, for example an 8 kHz interval, at the IXP1200 network processor 138. The network processor 138 increments a counter each time a packet is simulated by the packet receipt simulator 148. Thus, the network processor may increment the counter every 125 microseconds when the packet receipt simulator 148 simulates packets at an 8 kHz rate.

Where the network processor 138 is an IXP1200, the IXP1200 may be programmed to increment a 32-bit memory location each time the simulated packet receipt is simulated by the packet receipt simulator 148. Thus each increment is equal to an amount of time. The memory location that is incremented may be referred to as a “time stamp reference” and may be made available to various functions within the IXP1200 or to other devices coupled to the IXP1200. That time stamp reference may then be associated with packets as they are received, thereby acting as a time stamp on each packet.

In an embodiment, the packet receipt simulator 148 is an FPGA that appears to be a MAC to the network processor 138. Moreover, the packet receipt simulator 148 may exist in the same FPGA as the bridge 134 discussed in this application.

As an alternate to use of the packet receipt simulator 148, an external reference clock may be coupled to the network processor 138. Use of an external reference clock would, however, consume more bandwidth than the packet receipt simulator 148. Consumption of more bandwidth, in turn, reduces the maximum packet handling capacity of the network processor 138. Thus, the gateway beneficially provides a time stamp while minimizing bandwidth consumption.

While the system, apparatus, and method of communicating a packet queue status has been described in detail and with reference to specific embodiments thereof, it will be apparent to one skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A method of communicating queue status in a packet, comprising:
reading a plurality of queue statuses;
storing the plurality of queue statuses in memory; and
transmitting the queue statuses stored in memory in a packet format.

2. The method of claim 1, wherein the plurality of queue statuses are read from a plurality of memory locations of a first integrated circuit.

3. The method of claim 2, wherein the first integrated circuit is a signal processor.

4. The method of claim 3, wherein the plurality of queue statuses are read from a plurality of signal processors.

5. The method of claim 1, wherein the plurality of queue statuses are stored in memory of a memory-to-packet bridge.

6. The method of claim 5, wherein the memory to packet bridge is a field-programmable gate array.

7. The method of claim 1, wherein the queue statuses are transmitted in a packet format to a second integrated circuit.

8. The method of claim 7, wherein the second integrated circuit is a packet network processor.

9. A system for communicating queue status in a packet, comprising:
a first integrated circuit having memory containing a queue status;
a memory to packet bridge having memory, the memory to packet bridge reading the queue status from the first integrated circuit and storing that status in the memory to packet bridge memory; and
a second integrated circuit receiving the queue status from the memory to packet bridge in a packet format.

10. The system of claim 9, wherein the first integrated circuit is a signal processor.

11. The system of claim 9, wherein the memory to packet bridge is a field-programmable gate array.

12. The system of claim 9, wherein the second integrated circuit is a packet processor.

13. An article of manufacture comprising:
a computer readable medium having stored thereon instructions which, when executed by a processor, cause the processor to:
read a plurality of queue statuses;
store the plurality of queue statuses in memory; and
transmit the queue statuses stored in memory in a packet format.

14. The article of manufacture of claim 13, wherein the article of manufacture includes a field-programmable gate array.

15. A method for time stamping a packet, comprising:
receiving a regular periodic signal;
incrementing a counter each time the signal is received; and
applying the counter to the packet.

16. The method of claim 15, wherein the counter is associated with the packet by a processor when the packet is received at the processor.

17. The method of claim 16, further comprising determining a delay in receipt of the packet by comparing the counter associated with the packet to a time at which the packet was sent.

18. The method of claim 17 wherein the packet and the other packets comprise at least a portion of a data stream, further comprising adjusting an amount of time that packets are held prior to delivery to a user based on the delay in receipt of the packet.

19. The method of claim 15, further comprising multiplying the counter by the period between receipts of the signal to determine a time of receipt of the packet.

20. An article of manufacture comprising:
a computer readable medium having stored thereon instructions which, when executed by a processor, cause the processor to:
receive a regular periodic signal;
increment a counter each time the signal is received; and
apply the counter to the packet.

21. The article of manufacture of claim 20, wherein the article of manufacture includes a field-programmable gate array.
